(19) United States
(12) Patent Application Publication
(10) Pub. No.: US 2026/0038756 A1
(43) Pub. Date: Feb. 5, 2026

(54) PYROTECHNIC CIRCUIT BREAKER

(71) Applicant: AUTOLIV DEVELOPMENT AB, Vargarda (SE)

(72) Inventors: Maxime GRANDIAU, Thiescourt (FR); Frederic LAVAL, Survilliers (FR); Benjamin DUVERT, Chambly (FR)

(21) Appl. No.: 18/850,311

(22) PCT Filed: Feb. 27, 2023
(86) PCT No.: PCT/EP2023/054814

§ 371 Date: Apr. 30, 2025

(30) Foreign Application Priority Data
Mar. 29, 2022 (FR) FR2202796

(51) Int. Cl. H01H 39/00

(52) U.S. Cl. CPC H01H 39/006

(57) ABSTRACT

The invention relates to a pyrotechnic circuit breaker, comprising: a housing, an electrical conductor to be interrupted, a piston which is arranged in the housing to interrupt the electrical conductor and which can be moved between an idle position and an activated position in which the electrical conductor is interrupted, a pyrotechnic actuator arranged in the housing to cause the piston to move from the idle position to the activated position, the piston comprising a proximal end arranged on the side of the pyrotechnic actuator and a distal end opposite to the proximal end, wherein the piston comprises at least one gas passage arranged between the distal end and the proximal end.

### TECHNICAL FIELD OF THE INVENTION

The present invention relates in general to pyrotechnic circuit breakers, intended to equip electric vehicles in order to quickly cut off electric circuits (in particular traction circuits with high current intensities, and/or high electric voltages, and/or with high inductances). The currents flowing through such electrical circuits of electric vehicles may have intensities of several thousand or tens of thousands of amps, with voltages that may range from tens to thousands of volts.

### PRIOR ART

It is known in the prior art of circuit breakers to provide a gas passage in the housing between a breaking chamber, which initially comprises the electrical conductor to be broken, and a pyrotechnic chamber designed to receive combustion gases from the pyrotechnic actuator. However, this system may have the disadvantage of large dimensions and/or insufficient insulation resistance after operation (due to conductive deposits left by combustion gases). Document DE102019135591, for example, illustrates such a circuit breaker. For example, DE102018125059A1 illustrates a circuit breaker with a cooling channel.

### DISCLOSURE OF THE INVENTION

An object of the present invention is to overcome the shortcomings of the background art mentioned above and in particular, firstly, to propose a circuit breaker that is compact and/or that makes it possible to offer heightened operating safety.

A first aspect of the invention therefore relates to a pyrotechnic circuit breaker comprising:
a housing,
an electrical conductor to be interrupted,
a piston arranged in the housing to cut the electrical conductor and movable between an idle position and an activated position in which the electrical conductor is interrupted,
a pyrotechnic actuator arranged in the housing to cause the piston to move from the idle position to the activated position,
   the piston comprises a proximal end arranged on the side of the pyrotechnic actuator and a distal end opposite to the proximal end,
   characterized in that the piston comprises at least one gas passage, arranged between the distal end and the proximal end. According to the above embodiment, the circuit breaker comprises at least one gas passage arranged on or in the piston, providing a compact solution. In addition, fluid communication between the distal end and the proximal end limits or prevents the compression of the gases above the piston as it moves, thus increasing operating safety by preventing the piston from moving backward due to excessive pressure exerted by the gases compressed by the distal end.

In one embodiment, the piston (or passage) can comprise at least one orifice provided on the distal end side and/or on the proximal end side, so as to establish fluid communication between the distal end and the proximal end.

In one embodiment, the fluid communication can be permanent and/or independent of piston position. In other words, the passage can be designed to be constantly open, to facilitate/allow the passage of gas from one side of the piston to the other. Such a passage can be seen as a means of increasing the volume available for the gases within the chamber containing the conductor (which is to be interrupted before the circuit breaker is activated, and is interrupted after the circuit breaker is activated).

In one embodiment, the piston and/or the passage and/or the circuit breaker may be devoid of filtration means. The gases do not need to be cooled or filtered to ensure that there is no piston return or recoil.

In one embodiment, the piston and/or the passage and/or the circuit breaker may be devoid of vents and/or venting means. Thus makes it easy to guarantee environmental resistance.

In one embodiment, the proximal end can directly face the pyrotechnic actuator, at least when the piston is in the idle position.

In one embodiment, the distal end can directly face the electrical conductor to be interrupted, at least when the piston is in the idle position.

In one embodiment, the piston (or passage) can comprise at least one orifice located at the distal end and directly facing the electrical conductor to be interrupted, when the piston is in the idle position.

According to one embodiment, the proximal end can be a first end of the piston in a direction of piston travel, and the distal end can be a second end of the piston in a direction of piston travel.

According to one embodiment, when the piston is in the idle position, the housing can form with the piston:
a cut-off chamber comprising a portion of the electrical conductor to be interrupted,
a pyrotechnic chamber, designed to receive combustion gases from the pyrotechnic actuator,
a side chamber, separated from the cut-off chamber by the piston, and isolated from the pyrotechnic chamber,
   and the gas passage can place the cut-off chamber in fluid communication with the side chamber. According to the above implementation, the pyrotechnic chamber is isolated from the side chamber and the cut-off chamber by the piston, so that combustion gases remain confined in the pyrotechnic chamber: operating safety is improved, particularly with high post-operation isolation resistances.

According to one embodiment:
the housing may comprise an igniter well, and
the piston may comprise a skirt engaged in the igniter well and separating the side chamber from the pyrotechnic chamber. This structure is simple, with the skirt providing additional guidance. A gasket can be fitted to the skirt.

According to one embodiment:
the housing may comprise a main cylinder, and
the piston may comprise a peripheral surface engaged in the main cylinder, and the gas passage can be arranged between the peripheral surface and the piston skirt.

In one embodiment, the piston in the activated position can divide the cut-off chamber into a plurality of sub-chambers, and the piston can have at least one gas passage per sub-chamber to the side chamber. Even if the cut-off chamber is partitioned once the piston has been moved, the presence of multiple gas passages ensures that there is no excess pressure on the distal end, guaranteeing that the piston remains in its final position, without moving back.

In one embodiment, the pyrotechnic circuit breaker can include at least one cooling feature arranged to cool gases heated by an electric arc generated when the electrical conductor is interrupted. Such cooling features further enhance operating safety by preventing the gases from remaining hot, even if arcing occurs during operation; the pressure drops rapidly.

In one embodiment, said at least one cooling feature can be arranged in the cut-off chamber and/or in the side chamber.

In one embodiment, the at least one cooling feature can be attached to the housing and/or the piston. At least one cooling feature can be arranged in the gas path to force a passage through it for more effective cooling. For example, the gas passage may provide or lead to a cooling feature.

According to one embodiment, the gas generator may comprise:
a through-hole formed in the piston, or
an external groove formed in a lateral surface of the piston.

In one embodiment, the gas passage can have a cross-sectional area greater than or equal to 15 or even 25 mm². This surface can be obtained by one, two or more passes. Note that the passage is much larger than the mechanical clearance between two parts that must move relative to each other. Furthermore, manufacturing tolerances can cause a mechanical clearance between two moving parts to vary greatly, whereas the gas passage has a surface area that varies little, thus providing greater repeatability.

According to one embodiment, said at least one gas passage can allow gas communication into the housing so as to impose in the housing and for 1 ms after a peak of maximum pressure Pmax a pressure between Pmax and 0.9Pmax. The maximum pressure Pmax can be a maximum pressure measured during an operating test, and 0.9Pmax can represent 90% of the maximum pressure. The maximum pressure Pmax can be a maximum pressure measured in a cut-off chamber of the circuit breaker, that is in a chamber containing the conductor to be interrupted, and delimited at least in part by the distal end of the piston. According to this implementation, the passage of gas avoids an excessively high peak pressure, which results in a flatter pressure curve: The pressure varies little after the peak pressure. As a result, the piston is subjected to little stress and does not move back once it has reached its maximum displacement.

In one embodiment, the electrical conductor can pass through the housing.

In one embodiment, the gas passage can be arranged to allow, when the electrical conductor is interrupted, a movement of gases present from a side of the piston facing the electrical conductor when the piston is in the idle position to a side of the piston facing the pyrotechnic actuator when the piston is in the activated position.

A second aspect of the invention relates to a motor vehicle, comprising at least one pyrotechnic circuit breaker according to the first aspect of the invention.

### DESCRIPTION OF THE FIGURES

Other features and advantages of the present invention will become more apparent upon reading the following detailed description of an embodiment of the invention, which is provided by way of example but in no manner limited thereto, and illustrated by the attached drawings, in which:

FIG. 1 shows a cross-sectional view of a pyrotechnic circuit breaker according to the invention after activation of the pyrotechnic device, with a piston having interrupted an electrical conductor;

FIG. 2 shows a perspective view of the piston alone;

FIG. 3 shows voltage, current and pressure curves measured during operation in a circuit breaker of the prior art;

FIG. 4 shows voltage, current and pressure curves measured during operation in a circuit breaker according to the invention.

### DETAILED DESCRIPTION OF EMBODIMENT(S)

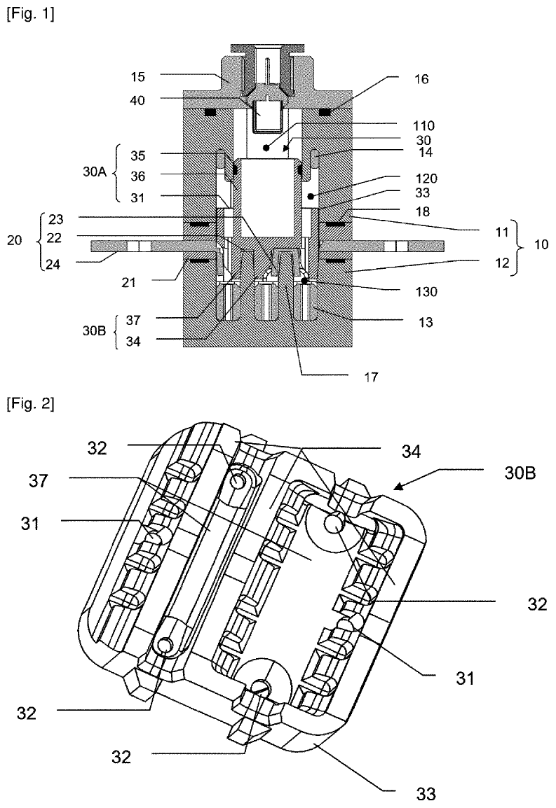

FIG. 1 shows a circuit breaker comprising:
a housing 10,
an electrical conductor to be interrupted 20,
a piston 30 arranged in the housing to cut the electrical conductor 20 and movable between an idle position and an activated position in which the electrical conductor 20 is interrupted,
a pyrotechnic actuator 40 arranged in the housing 10 to cause the piston 30 to move from the idle position to the activated position,
   the piston 30 comprising a proximal end 30A arranged on the side of the pyrotechnic actuator 40 and a distal end 30B opposite to the proximal end 30A.

In detail, the housing 10 of the circuit-breaker shown in FIG. 1 comprises a first half-shell 11 and a second half-shell 12. The first half-shell 11 accommodates an igniter support 15, which enables the attachment of an electro-pyrotechnic igniter forming the pyrotechnic actuator 40. The electrical conductor 20 consists mainly of an electrically conductive rod, which can be overmolded by a frame 21, sandwiched between the first half-shell 11 and the second half-shell 12. Note the presence of a plurality of gaskets 18 and 16 between the parts to guarantee good environmental resistance.

Generally speaking, the piston 30 is housed in the housing 10, so as to form:
-a cut-off chamber 130 comprising a portion of the electrical conductor 20 to be interrupted,
a pyrotechnic chamber 110, designed to receive combustion gases from the pyrotechnic actuator 40,
a side chamber 120, separated from the cut-off chamber 130 by the piston 30, and isolated from the pyrotechnic chamber 110 by the piston 30.

To this end, the housing 10 has a main cylinder and the piston 30 has a peripheral surface 33 housed in the main cylinder arranged to allow the piston 30 to slide in the housing 10.

The piston 30 also has:
-a skirt 36 and a seal 35 on the side of the proximal end 30A;
-a plurality of blades 34 separated by grooves 37 at the distal end 30B,
passages 31 (orifices) establishing fluid communication between the proximal end 30A and the distal end 30B. Opposite the grooves 37 separating the plurality of blades 34 from the piston 30, the second half-shell 12 has dies 17 which are designed to interlock with the piston 30 to interrupt the electrical conductor 20.

Indeed, as shown in FIG. 1, the pyrotechnic actuator 40 has been triggered and the piston 30 is therefore in an activated position in which the electrical conductor 20 has been cut into several pieces. As can be seen in FIG. 1, the electrical conductor 20 consists of the two outer ends 24 of the electrical conductor 20, a first cut piece 22 and a second cut piece 23. The piston 30, initially in its idle position in the first half-shell 11, has been moved by the pressurized gases from the pyrotechnic actuator 40 expelled into the pyrotechnic chamber 110 to occupy the activated position shown in FIG. 1. When moving from the idle position to the activated position, the piston 30 has cut the electrical conductor 20; the first cut piece 22 and the second cut piece 23 are then separated from the two external ends 24 and sandwiched between the piston 30 (knives 37 and grooves 37) on the one hand and the housing 10 (the dies 17) on the other.

The circuit breaker comprises cooling features 13, 14 arranged to cool gases, and the cut-off chamber 130 also contains cooling features arranged to cool gases heated by an electric arc generated during the interruption of the electrical conductor 20. The first cooling features 13 are housed in the cut-off chamber 130, and the second cooling features 14 are housed in the side chamber 120.

The cooling features can be metal parts. Porous parts or parts with internal voids can be provided. It is possible to provide the cooling features with a metal wire. Provision may be made to compact the metal wire on itself to form the cooling features. In other words, each cooling feature is formed with one or more compacted wires. It is also possible to provide a compacted knit, or even porous sintered parts. Such parts can dissipate energy from gases heated by an arc.

Indeed, according to one embodiment, the cooling features may be parts which are porous and/or with voids and/or with passages and/or with gaps, and/or with a density much lower than that of the metal from which they are formed, and which can easily be passed through by the gases, which provides a large exchange surface and an interesting cooling capacity for the gas of the cut-off chamber 130. It should be noted that during operation, the gases in the cut-off chamber 130 can be compressed/displaced by the movement of the piston 30, so that these gases move into the cooling features, within the free spaces, which enables an efficient heat exchange to cool the gases in the cut-off chamber 130. In other words, the cooling features can be designed for convection cooling (heat exchange between a gas and a solid).

FIG. 2 shows a perspective view of the distal end 30B, that is the face of the piston 30 that carries the blades 34 separated by the grooves 37. Note that the piston 30 has a non-circular peripheral surface 33, which ensures that the piston 30 slides without rotating around its axis: the assembly is a sliding connection. Thus, the blades 34 separated by the grooves 37 can perform an effective mechanical cut (shearing) of the electrical conductor 20 in cooperation with the dies 17 of the housing 10, which are properly aligned with the grooves 37.

There are two passages 31 in the cross-sectional plane of FIG. 1, and four passages 32 on either side of the cross-sectional plane of FIG. 1, each opening into a groove 37 of the piston 30.

As seen above and clearly visible in FIG. 1, the housing 10 defines:
at the proximal end 30A: the pyrotechnic chamber 110, and the side chamber 120 isolated from the pyrotechnic chamber 110 by the skirt 36 and seal 35 of the piston 30,
at the distal end 30B: the cut-off chamber 130, isolated or separated from the pyrotechnic chamber 110 and the side chamber 120 by the piston 30. However, the passages 31 and 32 in piston 30 ensure gas communication between the cut-off chamber 130 and side chamber 120. Consequently, the gas passages 31 and 32 are arranged to allow, when the electrical conductor 20 is interrupted, a movement of gases present on the side of the piston 30 facing the electrical conductor 20 when the piston 30 is in the idle position towards the side of the piston 30 facing the pyrotechnic actuator 40 when the piston 30 is in the activated position. This prevents gas overpressure in the cut-off chamber 130, since it should be remembered that the gases in the cut-off chamber 130 are compressed by the movement of the piston 30, which reduces their volume, and by any electric arcs that are established between the various pieces of the electrical conductor 20 and heat up the gases in the cut-off chamber 130. The piston 30 is therefore subjected to little or no force or pressure applied to the distal end 30B, which would tend to cause it to move backwards. The activated position of piston 30 is stronger and more stable.

It should also be noted that as the piston 30 moves, due to the interlocking of the dies 17 with or in the grooves 37, the initially one-piece cut-off chamber 130 is progressively segmented into cut-off sub-chambers. However, the various passages 31 and 32 are arranged on the piston 30 to ensure communication between the side chamber 120 and each of the cut-off sub-chambers. Thus avoids any risk of overpressure.

It should also be noted that the side chamber 120 is well-isolated from the pyrotechnic chamber 110, so that gases and combustion residues from the pyrotechnic actuator 40 remain confined to the pyrotechnic chamber 110 and do not enter the side chamber 120 or the cut-off chamber 130, and vice versa. Thus, the gases and residues from combustion of the pyrotechnic actuator 40 do not affect the insulation resistance between the ends 24, and the gases and residues from cutting the electrical conductor 20 do not affect the insulation resistance at the pins of the pyrotechnic actuator 40.

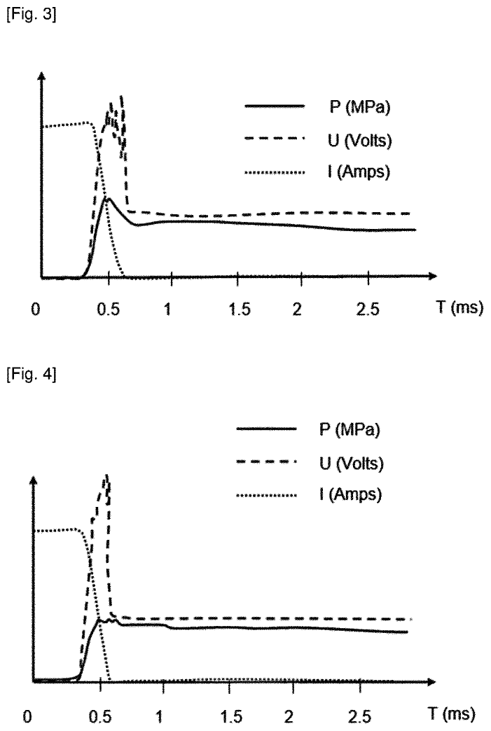

FIG. 3 shows measurements taken during operation of a prior-art circuit breaker, that is without gas flow through the piston. The graph in FIG. 3 shows:
a voltage curve across the electrical conductor,
a curve of the current flowing through the electrical conductor,
a curve of the pressure in the cut-off chamber.

At T=0 ms, current flows in the electrical conductor while the voltage across it is zero, because the electrical conductor is intact and conducts current perfectly. The igniter is fired and the piston begins to move.

At T=0.35 ms, pressure begins to rise in the cut-off chamber, current intensity decreases, and voltage increases; the piston has begun to physically cut the electrical conductor and an electric arc has been established.

At T=0.40 ms, the pressure in the cut-off chamber rises again, the current decreases further, and the voltage increases, as the piston continues to separate the electrical conductor into several cut pieces. Between T=0.5 ms and T=0.65 ms, the voltage is at its maximum, a pressure peak is reached and the voltage then drops to stabilize at the DC voltage of the open electric circuit, while the current becomes zero; the electric circuit is open and the arc is interrupted. Note that the pressure peak in this test was around 80 bar at 0.5 ms, and that at 1.5 ms (that is 1 ms after the pressure peak), the pressure is just under 60 bar.

FIG. 4 shows the same measurements as FIG. 3, but carried out during operation of a circuit breaker according to the invention, that is as in FIG. 1, with at least one gas passage in the piston, between the distal end 30B and the proximal end 30A. The rest of the circuit-breaker's structure and geometry is identical to the circuit-breaker used for the measurements in FIG. 3. The graph in FIG. 4 shows:
a voltage curve across the electrical conductor,
a curve of the current flowing through the electrical conductor,
a curve of the pressure in the cut-off chamber.

At T=0 ms, current flows in the electrical conductor while the voltage across it is zero, because the electrical conductor is intact and conducts current perfectly. The igniter is fired and the piston begins to move.

At T=0.35 ms, pressure begins to rise in the cut-off chamber, current intensity decreases, and voltage increases: the piston has begun to physically cut the electrical conductor and an electric arc has been established.

At T=0.40 ms, the pressure in the cut-off chamber rises again, the current decreases further, and the voltage increases, as the piston continues to separate the electrical conductor into several cut pieces. Between T=0.5 ms and T=0.65 ms, the voltage is at its maximum, a pressure peak is reached and the voltage then drops to stabilize at the DC voltage of the open electric circuit, while the current becomes zero: the electric circuit is open and the arc is interrupted. Note that the pressure peak in this test was around 60 bar at 0.5 ms, and that at 1.5 ms (that is 1 ms after the pressure peak), the pressure is just under 60 bar.

Compared to the curves shown in FIG. 3, we can see that the time during which the arc is present is shorter (we can consider that an arc is present as soon as the voltage is greater than zero, and that the arc is interrupted when the voltage is stabilized at the open circuit voltage, that is the battery voltage). FIG. 4 also shows that the maximum pressure peak is lower than in FIG. 3, which can be explained by the presence of the gas passages, which prevent the cut-off chamber from being pressurized. As a result of this lower pressure, the piston cuts the electrical conductor more effectively and more quickly, and the piston stays in place better in its final position, without moving backward: the partitioning provided by the piston is effective and limits the formation of the electric arc, for faster interruption.

It will be understood that various modifications and/or improvements which are obvious to a person skilled in the art may be made to the different embodiments of the invention described in the present description without departing from the scope of the invention.

In particular, it may be noted that passages 31 and 32 are orifices in the piston 30, but it may be possible to provide grooves in the side wall 33 of the piston 30. Note, however, that the gas passage area, equal to the sum of the areas of passages 31 and 32, is much greater than the peripheral clearance of the piston 30. In particular, the gas passage area can be greater than 6 mm², preferably greater than 9 mm², and even greater than 12 mm² per gas passage between a sub-chamber and the side chamber.

In addition, the igniter can be overmolded or crimped onto the housing 10 or the igniter support 15, depending on the materials chosen for the latter.

Apart from the electrical conductor 20 and the cooling features 13 and 14, all or some of the parts shown in FIG. 1 may be made of plastic and/or polymer and/or filler material. Polyamide can be used, with glass fibers or any other reinforcing material.

The plastic parts can be overmolded or reinforced with metal elements, depending on the stresses they have to withstand

The piston 30 may be provided in other forms, with more or fewer blades 34/grooves 37/dies 17.

The cooling features may be positioned on or in the piston 30. For example, it may be possible to place at least one cooling feature on, in or near at least one passage, so as to force a gas passage through the cooling feature and thus improve the cooling of the gases in the cut-off chamber.

### INDUSTRIAL APPLICATION

A circuit breaker according to the present invention, and its manufacture, are capable of industrial application.

1-14. (canceled)

15. A pyrotechnic circuit breaker, comprising:
-a housing,
an electrical conductor to be interrupted,
a piston arranged in the housing to cut the electrical conductor and movable between an idle position and an activated position in which the electrical conductor is interrupted,
a pyrotechnic actuator arranged in the housing to cause the piston to move from the idle position to the activated position,
the piston comprises a proximal end arranged on the side of the pyrotechnic actuator and a distal end opposite to the proximal end,
wherein the piston comprises at least one gas passage, arranged between the distal end and the proximal end.

16. The pyrotechnic circuit-breaker according to claim 15, wherein said at least one gas passage allows gas communication into the housing so as to impose in the housing and for 1 ms after a peak of maximum pressure Pmax a pressure of between Pmax and 0.9Pmax.

17. The pyrotechnic circuit breaker according to claim 15, in which, when the piston (is in the idle position, the housing forms with the piston:
a cut-off chamber comprising a portion of the electrical conductor to be interrupted,
a pyrotechnic chamber, designed to receive combustion gases from the pyrotechnic actuator,
a side chamber, separated from the cut-off chamber by the piston, and isolated from the pyrotechnic chamber,
wherein the gas passage places the cut-off chamber in fluid communication with the side chamber.

18. The pyrotechnic circuit breaker according to claim 17, wherein:
the housing comprises an igniter well, and
the piston comprises a skirt engaged in the igniter well and separating the side chamber from the pyrotechnic chamber.

19. The pyrotechnic circuit breaker according to claim 18, wherein:
the housing comprises a main cylinder, and
the piston comprises a peripheral surface engaged in the main cylinder,
and the gas passage is arranged between the peripheral surface and the piston skirt.

20. The pyrotechnic circuit breaker according to claim 17, wherein the piston in the activated position divides the cut-off chamber into a plurality of sub-chambers, and wherein the piston has per sub-chamber at least one gas passage to the side chamber.

21. The pyrotechnic circuit breaker according to claim 15, further comprising at least one cooling feature arranged to cool gases heated by an electric arc generated during the interrupting of the electrical conductor.

22. The pyrotechnic circuit breaker according to claim 21, wherein said at least one cooling feature is arranged in the cut-off chamber and/or in the side chamber.

23. The pyrotechnic circuit breaker according to claim 21, wherein said at least one cooling feature is attached to the housing and/or to the piston.

24. The pyrotechnic circuit breaker according to claim 15, wherein the gas passage is:
-a through-hole formed in the piston, or
an external groove formed in a lateral surface of the piston.

25. The pyrotechnic circuit breaker according to claim 15, wherein the gas passage has a cross-sectional area greater than or equal to 15 mm, or even 25 mm²

26. The pyrotechnic circuit breaker according to claim 15, wherein the electrical conductor passes through the housing.

27. The pyrotechnic circuit breaker according to claim 15, wherein the gas passage is arranged to allow, when the electrical conductor is interrupted, a movement of gases present from a side of the piston facing the electrical conductor when the piston is in the idle position towards a side of the piston facing the pyrotechnic actuator when the piston is in the activated position.

28. A motor vehicle comprising at least one pyrotechnic circuit breaker according to claim 15.
